(19) United States
(12) Patent Application Publication
(10) Pub. No.: US 2026/0057324 A1
(43) Pub. Date: Feb. 26, 2026

(54) Warehouse Dynamic Sequencing and Task Prioritization

(71) Applicant: Blue Yonder Group, Inc., Scottsdale, AZ (US)

(72) Inventors: Ankit Belchandan, Durg (IN); Sai Sridhar Varahabhatla, Bangalore (IN); Pankaj Rathoure, Hyderabad (IN)

(21) Appl. No.: 19/378,974

(22) Filed: Nov. 4, 2025

Related U.S. Application Data
(63) Continuation-in-part of application No. 19/270,846, filed on Jul. 16, 2025.
Application No. 19/270,846 is a continuation-in-part of application No. 19/016,238, filed on Jan. 10, 2025.
(60) Provisional application No. 63/549,150, filed on Feb. 2, 2024.
(60) Provisional application No. 63/551,788, filed on Feb. 9, 2024.
(60) Provisional application No. 63/553,285, filed on Feb. 14, 2024.
(60) Provisional application No. 63/874,252, filed on Sep. 2, 2025.
(60) Provisional application No. 63/880,740, filed on Sep. 12, 2025.
(60) Provisional application No. 63/880,755, filed on Sep. 12, 2025.

(51) Int. Cl. G06Q 10/0631

(52) U.S. Cl. CPC G06Q 10/06316; G06Q 10/06312

(57) ABSTRACT

A system and method are disclosed for generating and scheduling warehouse tasks. The method includes identifying changes in a warehouse plan for a warehouse within a supply chain network, generating tasks based on the identified changes, determining a task priority of the generated tasks, generating a task schedule based on the determined task priority, and monitoring real time execution of the generated tasks according to the task schedule. The method further includes performing, in real time, dynamic re-sequencing and dynamic re-scheduling to account for a deviation from the schedule and detecting, in real time, an error and transmitting, in real time, one or more tasks to a mobile device to account for the detected error.

### CROSS-REFERENCE TO RELATED APPLICATIONS

The present disclosure is a continuation-in-part of U.S. patent application Ser. No. 19/270,846, filed Jul. 16, 2025, entitled “Dynamic Sequencing and Scheduling of Warehouse Tasks,” which is a continuation-in-part of U.S. patent application Ser. No. 19/016,238, filed Jan. 10, 2025, entitled “Dynamic Sequencing and End to End Process of Planogram Adjustments,” which claims priority to U.S. Provisional Application No. 63/551,788, filed Feb. 9, 2024, entitled “Dynamic Sequencing and End to End Process of Planogram Adjustments,” U.S. Provisional Application No. 63/553,285, filed Feb. 14, 2024, entitled “Radial Visualization of Planogram Adjustments,” and U.S. Provisional Application No. 63/549,150, filed Feb. 2, 2024, entitled “Task Prioritization and Dynamic Modification of Task Sequence.” The present disclosure also claims priority to U.S. Provisional Application No. 63/874,252, filed Sep. 2, 2025, entitled “Supply Chain Fulfillment Using End-to-End Dynamic Tasking,” U.S. Provisional Application No. 63/880,740, filed Sep. 12, 2025, entitled “Sustainable Supply Chain Fulfillment based on Dynamic Tasking,” and U.S. Provisional Application No. 63/880,755, filed Sep. 12, 2025, entitled “Transportation Task Prioritization.” U.S. patent application Ser. Nos. 19/270,846 and 19/016,238 and U.S. Provisional Application Nos. 63/551,788, 63/553,285, 63/549,150, 63/874,252, 63/880,740 and 63/880,755 are assigned to the assignee of the present application.

### TECHNICAL FIELD

The present disclosure relates generally to warehouse planning and execution and specifically to detecting and executing changes in warehouse plans.

### BACKGROUND

In warehouse planning and execution, warehouse plans are generated for warehouses, distribution centers and the like periodically, such as daily, and thereafter executed by workers by picking, packing or transferring inventory or performing other jobs within the warehouse. However, in some situations a warehouse plan may be updated, such as a new warehouse plan being generated midway through a day or midway through a shift, for a variety of reasons, such as in response to the receipt of an unexpected number of orders or the receipt of orders with rush or expedited fulfillment. Further, during warehouse operations, unexpected changes not part of the warehouse plan may occur, necessitating updated plans or operational schedules. Using existing warehouse management systems, when a warehouse plan is updated for any reason, the associated warehouse may struggle to implement the updated warehouse plan effectively. For example, updated warehouse plans may be difficult for workers to understand, in some cases it may be overly complex to determine how to implement a warehouse plan change and any changes that are implemented may be performed ad-hoc and in an inefficient manner that disrupts the operation of the warehouse as a whole. For these reasons and more, existing warehouse data management systems that implement warehouse operational changes lack an ability to efficiently and competently implement updates or changes to warehouse execution and may disrupt warehousing and other fulfillment operations, all of which is undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with an embodiment;

FIG. 2 illustrates the warehouse tasking system, the archiving system and the planning and execution system of FIG. 1 in greater detail, in accordance with an embodiment;

FIG. 3 illustrates an example method for executing and monitoring changes in a warehouse plan, according to an embodiment;

FIG. 4 illustrates an example method for generating and scheduling warehouse tasks, according to an embodiment;

FIG. 5 illustrates an example method for optimizing warehouse tasks, according to an embodiment;

FIG. 6 illustrates an example method for optimizing receiving and put away tours, according to an embodiment;

FIG. 7 illustrates an example method for optimizing slot schedules and inventory allocations, according to an embodiment;

FIG. 8 illustrates an example method for optimal order batching and pick tours, according to an embodiment; and

FIG. 9 illustrates an example method for optimal pack station scheduling and shipment allocation, according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described in more detail below, embodiments of the following disclosure provide systems and methods to automatically detect changes in a warehouse or a warehouse plan and execute the detected changes via dynamic task generation, sequencing and scheduling. Embodiments may detect a change in a warehouse plan compared to an initial warehouse plan and generate, based on the change, one or more tasks to be performed to implement the change. Embodiments may also detect a change in warehouse execution based on real-time data and generate one or more tasks to be performed based on the change in warehouse execution. Embodiments may then determine task priority for the one or more tasks based at least in part on a task and change report and further generate a task schedule for the one or more tasks based on the task priority. Embodiments may then transmit to a device associated with the warehouse instructions to perform at least one task of the one or more tasks, with the at least one task selected according to the task schedule. Embodiments may then monitor execution of the at least one task in order to enable dynamic task sequencing and scheduling if a task is performed out of sequence.

Embodiments provide ensembled techniques that combine multiple algorithms to generate tasks, determine task priority and dynamically sequence and schedule tasks to be performed to implement warehouse changes. Use of embodiments may increase accuracy of warehouse task execution. Embodiments provide tools to view, analyze and execute warehouse tasks at several different scopes. Use of embodiment may reduce time spent on analyzing or identifying warehouse tasks as well as the time spent taking corrective measures following execution incorrectly performed. Use of embodiments provides effective and efficient handling of warehouse tasking by providing enhanced warehouse task understanding as well as determining and providing shortest possible paths to perform warehouse tasks. Use of embodiments may enable improved compliance with warehouse plans at both a warehouse level and a supply chain or supply chain network level.

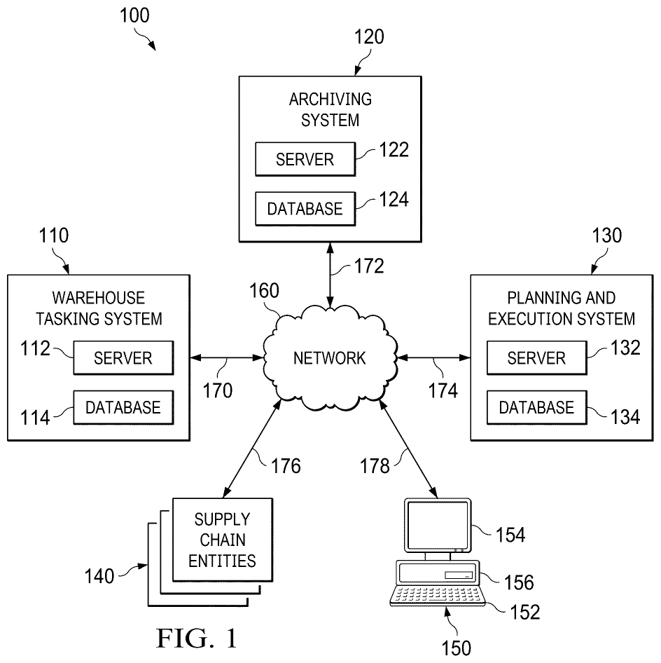

FIG. 1 illustrates supply chain network 100, in accordance with a first embodiment. Supply chain network 100 comprises warehouse tasking system 110, archiving system 120, planning and execution system 130, one or more supply chain entities 140, computer 150, network 160, and one or more communication links 172-178. Although a single warehouse tasking system 110, a single archiving system 120, a single planning and execution system 130, one or more supply chain entities 140, a single computer 150, a single network 160 and one or more communication links 172-178 are shown and described, embodiments contemplate any number of the above at one or more locations within or external to supply chain network 100, according to particular needs. In general, supply chain network 100 may operate to ultimately provide one or more items to one or more customers. As used herein, the word “item” includes products and services sold or made available by one or more entities of supply chain network 100, as well as raw materials or components that may be used in manufacturing processes of one or more entities of supply chain network 100, and the word “customer” includes both business or organizational clients, individual shoppers or consumers, as well as one or more supply chain entities 140 of supply chain network 100. Although one example of supply chain network 100 is shown and described, embodiments contemplate any configuration of supply chain networks 100 without departing from the scope of the present disclosure.

In one embodiment, warehouse tasking system 110 comprises server 112 and database 114. Although warehouse tasking system 110 is illustrated in FIG. 1 as comprising a single server 112 and a single database 114, embodiments contemplate warehouse tasking system 110 including any suitable number of servers 112 or databases 114, serverless computing options, or data stores, internal to or externally coupled with warehouse tasking system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores and/or other data storage systems, according to particular needs. As described in further detail below, warehouse tasking system 110 comprises one or more modules to perform an end-to-end process for updating warehouse plans in response to detected changes in warehouse plans or warehouse execution. For example, a warehouse plan may be generated by warehouse tasking system 110 or a separate system of supply chain network 100 for one of one or more supply chain entities 140, such as a warehouse or distribution center. In such an example, warehouse tasking system 110 may automatically detect required changes to the warehouse plans, such as changes required based on updated information about or relating to a warehouse associated with the warehouse plans or updates to orders to be fulfilled by the warehouse and generate one or more tasks to implement the required changes as described in further detail below. In embodiments, warehouse tasking system 110 may also detect changes to the execution of warehouse plans or deviations from normal warehouse operations and generate one or more tasks to implement the detected changes or to rectify the detected deviations.

Archiving system 120 comprises server 122 and database 124. Although archiving system 120 is shown as comprising a single server 122 and a single database 124, embodiments contemplate any suitable number of servers 122 or databases 124 internal to or externally coupled with archiving system 120. Server 122 may support one or more processes for receiving and storing data from warehouse tasking system 110, planning and execution system 130, one or more supply chain entities 140, computer 150 and/or other entities of supply chain network 100. According to some embodiments, archiving system 120 comprises an archive of data received from warehouse tasking system 110, planning and execution system 130, one or more supply chain entities 140, computer 150 and/or other entities of supply chain network 100. Archiving system 120 provides archived data to warehouse tasking system 110, planning and execution system 130 and/or other entities of supply chain network 100. Server 122 may store received data in database 124. Database 124 may comprise one or more databases or other data storage arrangements at one or more locations, local to, or remote from, server 122.

Planning and execution system 130 comprises server 132 and database 134. Supply chain planning and execution is typically performed by several distinct and dissimilar processes, including, for example, demand forecasting, production planning, supply planning, distribution planning, execution, transportation management, warehouse management, fulfillment, procurement, and the like. Server 132 comprises one or more modules, such as, for example, a sourcing module, a scheduling module, and/or a pick-pack-ship module for performing one or more order fulfillment processes. Server 132 stores and retrieves data from database 134 or one or more locations in supply chain network 100. In addition, planning and execution system 130 may operate on one or more computers that are integral to or separate from the hardware and/or software that support archiving system 120 and warehouse tasking system 110.

One or more supply chain entities 140 represent one or more suppliers, manufacturers, distribution centers and/or retailers in one or more supply chains or supply chain networks 100, including one or more enterprises. One or more suppliers may be any suitable entity that offers to sell or otherwise provides one or more items or components to one or more manufacturers or buyers. One or more suppliers may, for example, receive an item from a first supply chain entity 140 in supply chain network 100 and provide the item to another supply chain entity 140, which in some embodiments may be a buyer, a customer or an end user. Items may comprise, for example, components, materials, products, parts, supplies, or other items, that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers, for example, based on instructions from planning and execution system 130 or another entity or device of supply chain network 100.

A manufacturer may be any suitable entity that manufactures at least one product. A manufacturer may use one or more items during the manufacturing process to produce any manufactured, fabricated, assembled, or otherwise processed item, material, component, good or product. In one embodiment, a product represents an item ready to be supplied to, for example, another supply chain entity 140, such as a supplier, an item that needs further processing, or any other item. A manufacturer may, for example, produce and sell a product to a supplier, another manufacturer, a distribution center, a retailer, a customer, or any other suitable person or an entity. Such manufacturers may comprise automated robotic production machinery that produce products automatically, for example, based on instructions from planning and execution system 130 or another entity or device of supply chain network 100.

One or more distribution centers, which may also be called warehouses, may be any suitable entity that offers to sell or otherwise distributes at least one product to one or more retailers and/or customers. Distribution centers may, for example, receive a product from a first supply chain entity 140 in supply chain network 100 and store and transport the product for a second supply chain entity 140. Such distribution centers may comprise automated warehousing systems that automatically transport products to one or more retailers or customers and/or automatically remove an item from, or place an item into, inventory, for example, based on instructions from planning and execution system 130 or another entity or device of supply chain network 100.

One or more retailers may be any suitable entity that obtains one or more products to sell to one or more customers. In addition, one or more retailers may sell, store, and supply one or more components and/or repair a product with one or more components. One or more retailers may comprise any online or brick and mortar location, including locations with shelving systems. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location, for example, based on instructions from planning and execution system 130 or another entity or device of supply chain network 100.

The same supply chain entity 140 may simultaneously act as any one or more suppliers, manufacturers, distribution centers and retailers. For example, one or more supply chain entities 140 acting as a manufacturer could produce a product, and the same entity could act as a supplier to supply a product to another supply chain entity 140. Although one example of a supply chain network is shown and described, embodiments contemplate any configuration of supply chain network 100, without departing from the scope of the present disclosure.

Supply chain network 100 comprising warehouse tasking system 110, archiving system 120 and planning and execution system 130 may operate on one or more computers, such as the illustrated computer 150, that are integral to or separate from the hardware and/or software that support warehouse tasking system 110, archiving system 120 and planning and execution system 130. Computer 150 may include any suitable input device 152, such as a keypad, mouse, touch screen, microphone, or other device to input information. Computer 150 may further include output device 154, which may convey information associated with the operation of supply chain network 100, including digital or analog data, visual information, or audio information. Computer 150 may include fixed or removable computer-readable storage media 156, including a non-transitory computer-readable medium, magnetic computer disks, flash drives, CD-ROM, in-memory device, or other suitable media to receive output from and provide input to supply chain network 100.

Computer 150 may include one or more processors and associated memory to execute instructions and manipulate information according to the operation of supply chain network 100 and any of the methods described herein. In addition, or as an alternative, embodiments contemplate executing the instructions on computer 150 that cause one or more other computers or devices to perform functions of the method. An apparatus implementing special purpose logic circuitry, for example, one or more field-programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations, local to, or remote from warehouse tasking system 110, archiving system 120 and planning and execution system 130. In addition, computer 150 may be a workstation, personal computer (PC), network computer, notebook computer, tablet, personal digital assistant (PDA), cell phone, telephone, smartphone, augmented or virtual reality headset, or any other suitable computing device.

In one embodiment, warehouse tasking system 110, archiving system 120, planning and execution system 130, one or more supply chain entities 140 and computer 150 may be coupled with network 160 using one or more communication links 172-178, which may be any wireline, wireless or other link suitable to support data communications between warehouse tasking system 110, archiving system 120, planning and execution system 130, one or more supply chain entities 140, computer 150 and network 160 during operation of supply chain network 100. Although one or more communication links 172-178 are shown as generally coupling warehouse tasking system 110, archiving system 120, planning and execution system 130, one or more supply chain entities 140 and computer 150 to network 160, any of warehouse tasking system 110, archiving system 120, planning and execution system 130, one or more supply chain entities 140 and computer 150 may communicate directly with each other, using, for example, direct-line communication links, according to particular needs.

In another embodiment, network 160 includes the Internet and any appropriate local area networks (LANs), metropolitan area networks (MANs), or wide area networks (WANs) coupling warehouse tasking system 110, archiving system 120, planning and execution system 130, one or more supply chain entities 140 and computer 150. For example, data may be maintained locally too, or externally of, warehouse tasking system 110, archiving system 120, planning and execution system 130, one or more supply chain entities 140 and computer 150 and made available to one or more associated users of warehouse tasking system 110, archiving system 120, planning and execution system 130, one or more supply chain entities 140 and computer 150. using network 160 or in any other appropriate manner. For example, data may be maintained in a cloud database at one or more locations external to warehouse tasking system 110, archiving system 120, planning and execution system 130, one or more supply chain entities 140 and computer 150 and made available to one or more associated users of warehouse tasking system 110, archiving system 120, planning and execution system 130, one or more supply chain entities 140 and computer 150 using the cloud or in any other appropriate manner. Those skilled in the art will recognize that the complete structure and operation of network 160 and other components within supply chain network 100 are not depicted or described. Embodiments may be employed in conjunction with known communications networks and other components.

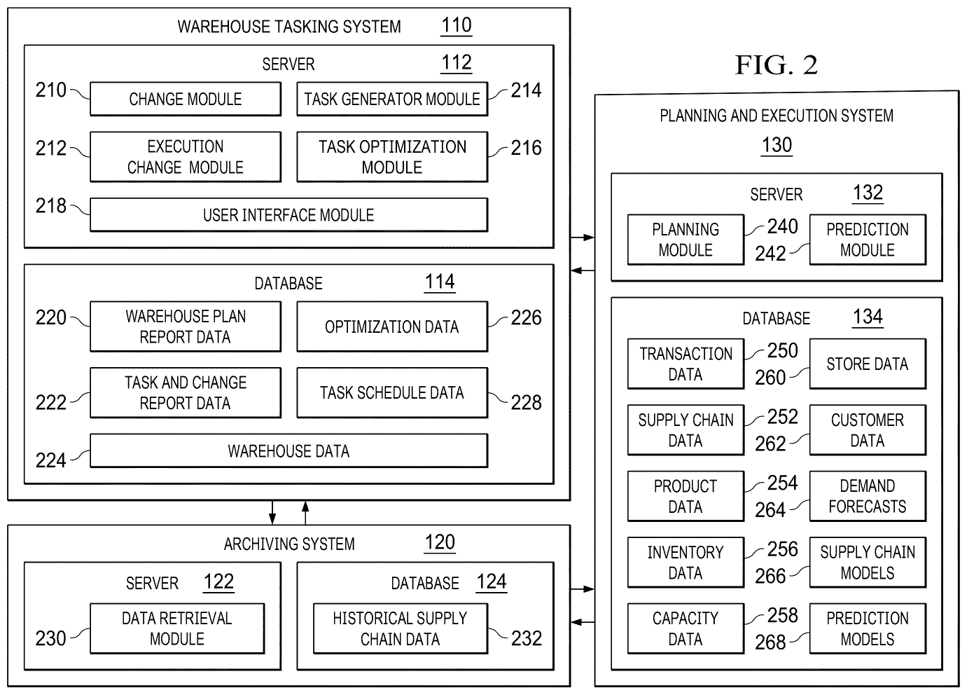

FIG. 2 illustrates warehouse tasking system 110 of FIG. 1 in greater detail in accordance with an embodiment. As discussed above, warehouse tasking system 110 may comprise one or more computers at one or more locations within or external to supply chain network 100, including any associated input or output devices. Although warehouse tasking system 110 is shown as comprising a single server 112 and a single database 114, embodiments contemplate any suitable number of computers, servers, or databases internal to, externally coupled with or remotely connected to warehouse tasking system 110. According to some embodiments, warehouse tasking system 110 may be located internal to a warehouse, distribution center or other supply chain entity 140, while in other embodiments, warehouse tasking system 110 may be located external to a warehouse or other supply chain entities 140 and may be located in, for example, a headquarters of an entity or company operating warehouses, according to particular needs.

Server 112 comprises change module 210, execution change module 212, task generator module 214, task optimization module 216 and user interface module 218. Although server 112 is illustrated and described as having several distinct and discrete modules performing various functions or tasks, embodiments contemplate the functions of server 112 and/or the various modules being performed by any number of software or hardware modules, applications or sub-routines including fewer than or more than the number of illustrated modules, according to needs. Although server 112 is illustrated and described as comprising a single change module 210, a single execution change module 212, a single task generator module 214, a single task optimization module 216 and a single user interface module 218, embodiments contemplate any suitable number or combination of these located at one or more locations, local to, or remote from warehouse tasking system 110, such as on multiple servers or computers at any location in supply chain network 100.

Database 114 may comprise one or more databases or other data storage arrangements at one or more locations, local to, or remote from, server 112. Database 114 comprises, for example, warehouse plan report data 220, task and change report data 222, warehouse data 224, optimization data 226 and task schedule data 228. Although database 114 is illustrated and described as comprising warehouse plan report data 220, task and change report data 222, warehouse data 224, optimization data 226 and task schedule data 228, embodiments contemplate any suitable number or combination of these, located at one or more locations, local to, or remote from, warehouse tasking system 110 according to particular needs. While the illustrated data is shown within a single database 114 for simplicity of explanation, in embodiments data may be stored separately either physically or logically for data security, data privacy, data integrity and confidentiality purposes.

In an embodiment change module 210 identifies changes in a warehouse plan based on warehouse plan report data. Warehouse plans may include warehouse slotting plans for new inventory including inbound product separation or handling rules, sub-movements required to perform inventory put away and vehicle passage plans, as well as outbound fulfillment plans including travel paths and outbound product separation or handling rules. A warehouse plan may be used during the execution or operation of a warehouse or distribution center, to guide the performance of tasks or jobs within the warehouse. Changes may be made to warehouse plans for several reasons, including increases or reductions in orders to be fulfilled, the receipt of transfer or spillover inventory from other warehouses or various other events that may occur during warehouse operations. To identify changes in warehouse plans, change module 210 may compare an initial warehouse plan with an updated or revised warehouse plan in order to identify changes from the initial warehouse plan to the updated warehouse plan. Possible changes may include changes in warehouse slotting, changes in product separation or handling rules, changes in available vehicles or vehicle routes, changes in travel paths or any other changes or warehouse or fulfillment plans.

In an embodiment execution change module 212 detects changes in warehouse execution processes using real time data such as data obtained from warehouse cameras or other warehouse sensors, including executed task data for the warehouse and resource usage data for the warehouse. Execution change module 212 may detect changes such as changes in tasking assignment due to unavailability of an assigned task, such as if items associated with a task are not present in an expected location or an item is delayed elsewhere in the warehouse, changes in resource or equipment, such as due to breakdown or required maintenance, partial non-functionality or if a resource, equipment or vehicle is otherwise unavailable, changes in labor availability such as due to employee call-outs, changes in cross-functioning, such as micro changes to labor responsibility or repurposing of equipment and changes in sub-movements such as detecting that one or more required sub-movements were not properly assigned in the warehouse plan. Any changes or issues detected by execution change module 212 may be used by task generator module 214 to generate tasks in response to such changes or issues.

In an embodiment task generator module 214 generates a set of tasks based on changes identified in warehouse plans or during warehouse execution. For example, task generator module 214 may associate each identified change with one or more tasks needed to execute the change, such as putting away inventory, picking inventory for fulfillment, moving or operating equipment or vehicles or any other tasks needed to implement changes in a warehouse. In embodiments, warehouse tasking system 110 may accept user input defining or limiting the scope of a warehouse analysis. In such embodiments, task generator module 214 may limit the tasks produced based on the scope defined by the user and only generate a task list including tasks within the limited scope defined by the user. For example, if the user has limited the scope of the warehouse analysis to one employee or set of employees of the warehouse, task generator module 214 may only generate tasks related to such employees.

In an embodiment task optimization module 216 determines a task priority for the tasks generated by task generator module 214 and further generates a task schedule for the tasks based on the task priority. Using information of the warehouse including physical layout, available travel routes, slots and stacked product information, resource or equipment availability and available labor, task optimization module 216 may calculate a task cost associated with performing tasks in a particular sequence to determine a lowest-cost task sequence for the tasks. In embodiments, task cost may be defined as a time needed to complete a task sequence including the time needed to walk or move between task locations. For example, if a set of tasks includes three tasks, with two tasks located in a first aisle and the third task located in a different aisle, performing the two tasks in the first aisle consecutively will result in a faster task performance, and thus a lower task cost, than performing the third task in between the two tasks located in the first aisle. In embodiments, task optimization module 216 may update the task schedule in real time based on changing conditions within a warehouse, such as increased traffic in one area of the warehouse compared to another, which will increase the time needed to complete tasks in the area of the warehouse with increased traffic. Task optimization module 216 may also dynamically re-determine task priority and task schedules based on task performance deviating from an initial task priority sequence. Task optimization module 216 may perform various sub-processes to determine an optimal task sequence and priority for a warehouse, including determining an optimal receiving and precise put away tour, determining optimal slot scheduling and inventory allocation, determining an optimal order batching and pick tour and determining optimal pack station scheduling and shipment allocation, as described in further detail below.

In an embodiment user interface module 218 generates and displays a user interface (UI), such as, for example, a graphical user interface (GUI), that displays warehouse plans, warehouse tasks or any other data of warehouse tasking system 110 in charts or graphs, or any other visual representations of data of warehouse tasking system 110. According to embodiments, user interface module 218 displays a GUI comprising interactive graphical elements for selecting one or more warehouse plans and/or data of any kind stored in the database of warehouse tasking system 110, and, in response to the selection, displaying the selected data on one or more display devices. User interface module 218 may generate interfaces for warehouse plans or warehouse tasks to be performed and transmit the interfaces to devices associated with users, such as smartphones or tablets of employees within a warehouse. The users may then use the interfaces to assist in the performance warehouse tasks in a task schedule, such as according to a task schedule generated by task optimization module 216. In embodiments, user interface module 218 may generate non-visual interfaces, such as voice-based personal assistants or email messages or other text-based messages, and present warehouse data or warehouse plan data to customers over such voice-based or text-based interfaces.

In an embodiment warehouse plan report data 220 comprises data of one or more warehouse plans or warehouse plan reports including but not limited to the physical locations and stacking of inventory within a warehouse. Warehouse plan report data 220 may include data of initial warehouse plans as well as data of changed or updated warehouse plans which include one or more changes due to received orders or any planning changes within supply chain network 100. Warehouse plan data may differ for inbound or put-away operations compared to outbound or pick-up operations. For example, for inbound operations, warehouse plan report data 220 may include initial warehouse slotting plans, inbound product separation handling rules, sub-movements required to perform put-away and vehicle passage data, while for outbound operations warehouse plan report data 220 may include warehouse outbound fulfillment plans and travel paths, outbound product separation handling rules and vehicle passage data. Warehouse slotting plans and warehouse outbound fulfillment plans may further include slot or position of pick or pick-up, slot or position of put-away or drop and equipment or resources needed to perform activities including travel paths. Product separation handling rules may include product types, quantity of products and put-way/pick-up quantity, product volume and product weight. Vehicle passage data may include vehicle (e.g., forklift) capacity route cost and labor availability and task assignment data. In embodiments, warehouse plan report data 220 may be retrieved from archiving system 120 or planning and execution system 130, such as from warehouse data 224 of planning and execution system 130. In embodiments, warehouse plan report data 220 may be used by change module 210 to identify changes within warehouse plans.

In an embodiment task and change report data 222 comprises a list or report of all changes identified between an initial warehouse plan and a revised warehouse plan, as well as the tasks needed to execute the identified changes. For example, each change identified between warehouse plans will be associated with one or more tasks that will need to be implemented or executed in order to effectuate the change. In embodiments, task and change report data 222 may be generated by change module 210 and task generator module 214 and used by task optimization module 216 to determine a task sequence and task schedule for the tasks.

In an embodiment warehouse data 224 comprises data relevant to determining task priority for a warehouse. Warehouse data 224 may include physical layout data for a warehouse including area and location data, travel routes and aisles, slots and stacked inventory data, resource data and labor data including assigned tasks and the impact of assigned tasks. In embodiments, warehouse data 224 may also include real-time data relating to the warehouse, available labor of the warehouse and resources or equipment of the warehouse, such as data obtained from cameras or other sensors, including Internet of Things (IOT) sensors. Warehouse data 224 may also include other real-time warehouse information, such as the location and travel routes of employees or vehicles within the warehouse based on captured visual information and warehouse plan data. In embodiments, warehouse data 224 may be used by task optimization module 216 to determine a task sequence and task schedule for a set of tasks.

In an embodiment optimization data 226 comprises data generated during task optimization and scheduling. For example, optimization data 226 may include refinements or changes to warehouse plans or warehouse tasks generated during tasks optimization such as receiving and put away tour refinements, automatic slot schedules and inventory allocations, order batching and pick tour refinements and refined packing station schedules and shipment allocations. Such refinements or changes may be generated to increase picking efficiency and improved throughput of the warehouse, to reduce travel time and improve resource utilization and to allow for faster put-away and retrieval times, better space utilization and more balanced workloads with faster order completions. In embodiments, optimization data 226 may be generated by task optimization module 216 and may be used by task optimization module 216 to determine a task sequence and task schedule for a set of tasks.

In an embodiment task schedule data 228 comprises a schedule of tasks calculated to have a most efficient completion time for the set of tasks compared to all other possible schedules of the tasks. Task schedule data 228 may include one or more tasks, paths or sequences to travel for task performance, scheduled times for tasks, an estimate of total time required to perform the one or more tasks, information of any equipment needed to perform the one or more tasks and a total route cost for the one or more tasks. Task schedule data 228 may be displayed on devices associated with users of warehouse tasking system 110 in order to allow the tasks to be performed according to the schedule of task schedule data 228. Task schedule data 228 may differ for inbound or put-away operations compared to outbound or pick-up operations. For example, for inbound operations task schedule data 228 may include a refined warehouse slotting plan, refinements to receiving and put-away tours, a slot schedule and an inventory allocation plan, while for outbound operations task schedule data 228 may include a refined warehouse outbound fulfillment plan, refinements to order batching and pickup tours, a refined packing station schedule, a refined shipment allocation plan, a slot schedule and an inventory picking plan. In embodiments, task schedule data 228 may be generated by task optimization module 216 and used by user interface module 218 to display task schedules or individual tasks to users or employees of a warehouse.

As discussed above, archiving system 120 comprises server 122 and database 124. Although archiving system 120 is shown as comprising a single server 122 and a single database 124, embodiments contemplate any suitable number of servers 122 or databases 124 internal to or externally coupled with archiving system 120. Server 122 comprises data retrieval module 230. Although server 122 is shown and described as comprising a single data retrieval module 230, embodiments contemplate any suitable number or combination of data retrieval modules located at one or more locations, local to, or remote from archiving system 120, such as on multiple servers or computers at one or more locations in supply chain network 100.

Database 124 may comprise one or more databases or other data storage arrangements at one or more locations, local to, or remote from, server 122. Database 124 comprises, for example, historical supply chain data 232. Although database 124 is shown and described as comprising historical supply chain data 232, embodiments contemplate any suitable number or combination of data, located at one or more locations, local to, or remote from, archiving system 120, according to particular needs.

In one embodiment, data retrieval module 230 receives historical supply chain data 232 from planning and execution system 130 or one or more supply chain entities 140 and stores the received historical supply chain data in database 124. According to one embodiment, data retrieval module 230 may prepare historical supply chain data 232 for use by checking historical supply chain data 232 for errors and transforming historical supply chain data 232 to normalize, aggregate, and/or rescale historical supply chain data 232 to allow direct comparison of data received from different planning and execution systems 130 or different supply chain entities 140. In embodiments, data retrieval module 230 may retrieve data from one or more sources external to supply chain network 100, such as, for example, weather data, special events data, social media data, calendar data, and the like and stores the received data as historical supply chain data 232.

Historical supply chain data 232 comprises historical data received from warehouse tasking system 110, planning and execution system 130, one or more supply chain entities 140, computer 150 or any other entity or device of supply chain network 100. Historical supply chain data 232 may comprise, for example, weather data, special events data, social media data, calendar data, and the like. In an embodiment, historical supply chain data 232 may comprise, for example, historic order data, shipment data and return data. In an embodiment, historical supply chain data 232 may comprise, for example, historic sales patterns, prices, promotions, weather conditions and other factors influencing future demand of the number of one or more items sold in supply chain network 100 over a time period, such as, for example, one or more days, weeks, months, years, including, for example, a day of the week, a day of the month, a day of the year, week of the month, week of the year, month of the year, special events, paydays or any other time period.

As discussed above, planning and execution system 130 comprises server 132 and database 134. Although planning and execution system 130 is shown as comprising a single server 132 and a single database 134, embodiments contemplate any suitable number of servers 132 or databases 134 internal to or externally coupled with planning and execution system 130. Server 132 comprises planning module 240 and prediction module 224. Although server 132 is shown and described as comprising a single planning module 240 and a single prediction module 242, embodiments contemplate any suitable number or combination of planning modules 240 and prediction modules 242 located at one or more locations, local to, or remote from planning and execution system 130, such as on multiple servers or computers at one or more locations within or external to supply chain network 100.

Database 134 may comprise one or more databases or other data storage arrangements at one or more locations, local to, or remote from, server 132. Database 134 comprises, for example, transaction data 250, supply chain data 252, product data 254, inventory data 256, capacity data 258, store data 260, customer data 262, demand forecasts 264, supply chain models 266 and prediction models 268. Although database 134 is shown and described as comprising transaction data 250, supply chain data 252, product data 254, inventory data 256, capacity data 258, store data 260, customer data 262, demand forecasts 264, supply chain models 266 and prediction models 268, embodiments contemplate any suitable number or combination of data, located at one or more locations, local to, or remote from, planning and execution system 130, according to particular needs.

Planning module 240 works in connection with prediction module 242 to generate a plan based on one or more predicted retail volumes, classifications, or other predictions. By way of example and not of limitation, planning module 240 may comprise a demand planner that generates a demand forecast for one or more supply chain entities 140. Planning module 240 may generate the demand forecast, at least in part, from predictions and calculated factor values for one or more causal factors received from prediction module 242.

Prediction module 242 applies samples of transaction data 250, supply chain data 252, product data 254, inventory data 256, store data 260, customer data 262, demand forecasts 264 and other data to prediction models 268 to generate predictions for one or more supply chain entities 140. In embodiments, prediction module 242 predicts a volume Y (target) from a set of causal factors X along with causal factors strengths that describe the strength of each causal factor variable contributing to the predicted volume. According to some embodiments, prediction module 242 generates predictions at daily intervals. However, embodiments contemplate longer and shorter prediction phases that may be performed, for example, weekly, twice a week, twice a day, hourly, or the like.

In an embodiment transaction data 250, comprises order data, shipment data, recorded sales and returns transactions and related data, including, for example, a transaction identification, time and date stamp, channel identification (such as stores or online touchpoints), product identification, actual cost, selling price, sales volume, customer identification, promotions, and or the like. In addition, transaction data 250 is represented by any suitable combination of values and dimensions, aggregated or un-aggregated, such as, for example, sales per week, sales per week per location, sales per day, sales per day per season, or the like.

In an embodiment supply chain data 252 comprises any data of one or more supply chain entities 140 including, for example, item data, identifiers, metadata (comprising dimensions, hierarchies, levels, members, attributes, cluster information, and member attribute values), fact data (comprising measure values for combinations of members), business constraints, goals and objectives of one or more supply chain entities 140.

In an embodiment product data 254 comprises products identified by, for example, a product identifier (such as a Stock Keeping Unit (SKU), Universal Product Code (UPC) or the like), and one or more attributes and attribute types associated with the product ID. Product data 254 may comprise data about one or more products organized and sortable by, for example, product attributes, attribute values, product identification, sales volume, demand forecast, or any stored category or dimension. Attributes of one or more products may be, for example, any categorical characteristic or quality of a product, and an attribute value may be a specific value or identity for the one or more products according to the categorical characteristic or quality, including, for example, physical parameters (such as, for example, size, weight, dimensions, color, and the like).

In an embodiment inventory data 256 comprises any data relating to current or projected inventory quantities or states, order rules, or the like. For example, inventory data 256 may comprise the current level of inventory for each item at one or more stocking points or warehouses across supply chain network 100. In addition, inventory data 256 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 256 in database 134, which may be used by planning and execution system 130 to place orders, set inventory levels at one or more stocking points, initiate manufacturing of one or more components, or the like.

In embodiments, inventory data 256 may further comprise one or more inventory policies. The inventory policies may comprise any suitable inventory policy describing the reorder point and target quantity, or other inventory policy parameters that set rules for planning and execution system 130 to manage and reorder inventory. The inventory policies may be based on target service level, demand, cost, fill rate, or the like. According to embodiments, the inventory policies comprise target service levels that ensure that a service level of one or more supply chain entities 140 is met with a set probability. For example, one or more supply chain entities 140 may set a service level at 95%, meaning supply chain entities will set the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs may comprise a min./max. (s,S) inventory policy. Other inventory policies may be used for perishable goods, such as fruit, vegetables, dairy, fresh meat, as well as electronics, fashion, and similar items for which demand drops significantly after a next iteration of a product is released.

In an embodiment capacity data 258 comprises any data relating to current or projected resource capacity values or states, order rules, or the like. For example, capacity data 258 may comprise the current level of capacity for each task at one or more locations across supply chain network 100. In addition, capacity data 258 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 258 in database 134, which may be used by planning and execution system 130 to place orders, set capacity levels at one or more locations in supply chain network 100, initiate manufacturing of one or more components, or the like.

In embodiments, capacity data 258 may further comprise one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning supply chain entities will set the desired capacity level at a level that meets demand 95% of the time.

In an embodiment store data 260 comprises data describing the physical retail stores of one or more retailers and related store information. Store data 260 may comprise, for example, a store ID, store description, store location details, store location climate, store type, store opening date, lifestyle, store area (expressed in, for example, square feet, square meters, or other suitable measurement), latitude, longitude, store layouts, employee data for stores, planograms for merchandising with the store and other similar data.

In an embodiment customer data 262 comprises customer identity information, including, for example, customer relationship management data, loyalty programs, and mappings between product purchases and one or more customers so that a customer associated with a transaction may be identified. Customer data 262 may comprise data relating customer purchases to one or more products, geographical regions, store locations, or other types of dimensions.

In an embodiment demand forecasts 264 comprise any data produced as part of a demand forecast process and may indicate future expected demand based on, for example, any data relating to past sales, past demand, purchase data, promotions, events, or the like of one or more supply chain entities 140. Demand forecasts 264 may cover a time interval such as, for example, by the minute, hour, daily, weekly, monthly, quarterly, yearly, or any other suitable time interval, including substantially in real time. Demand may be modeled as a negative binomial or Poisson-Gamma distribution. According to other embodiments, the model also takes into account shelf-life of perishable goods (which may range from days (e.g. fresh fish or meat) to weeks (e.g. butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors.

In an embodiment supply chain models 266 comprise models which describe the characteristics of a supply chain or supply chain network, such as supply chain network 100, including a setup to deliver the customer expectations or a particular customer business model. These characteristics may comprise differentiating factors, such as, for example, MTO (Make-to-Order), ETO (Engineer-to-Order) or MTS (Make-to-Stock). However, supply chain models 266 may also comprise characteristics that specify the supply chain structure in even more detail, including, for example, specifying the type of collaboration with the customer (e.g. Vendor-Managed Inventory (VMI)), from where products may be sourced, and how products may be allocated, shipped, or paid for, by particular customers. Each of these characteristics may lead to a different supply chain model.

In an embodiment prediction models 268 comprise one or more trained artificial intelligence (AI) or machine learning (ML) models used by planning and execution system 130 for predicting, among other variables, pricing, targeting, or retail volume, such as, for example, a forecasted demand volume for one or more products at one or more stores of one or more retailers based on the prices of the one or more products.

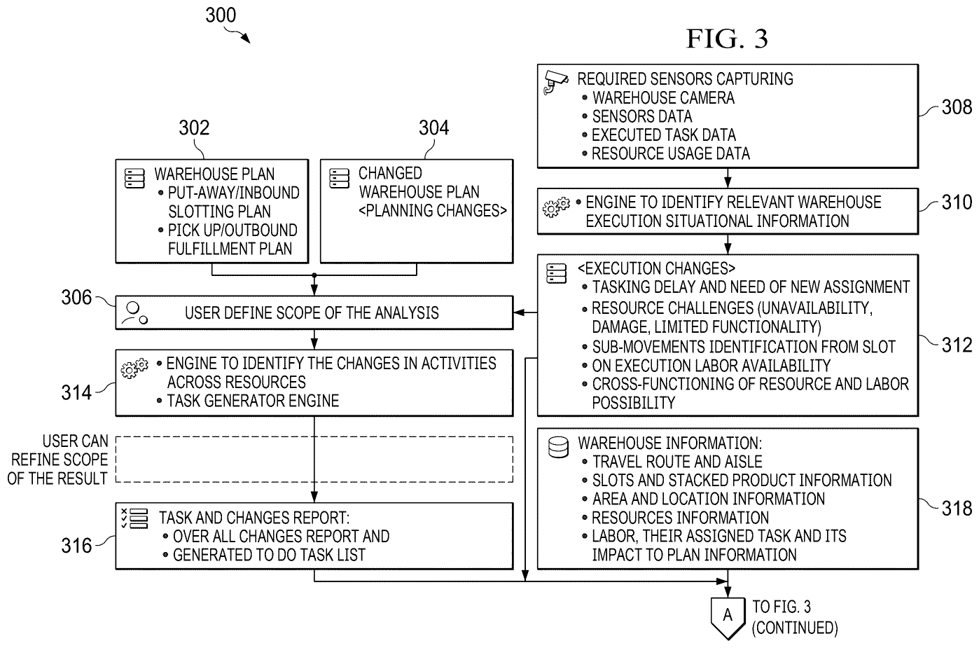

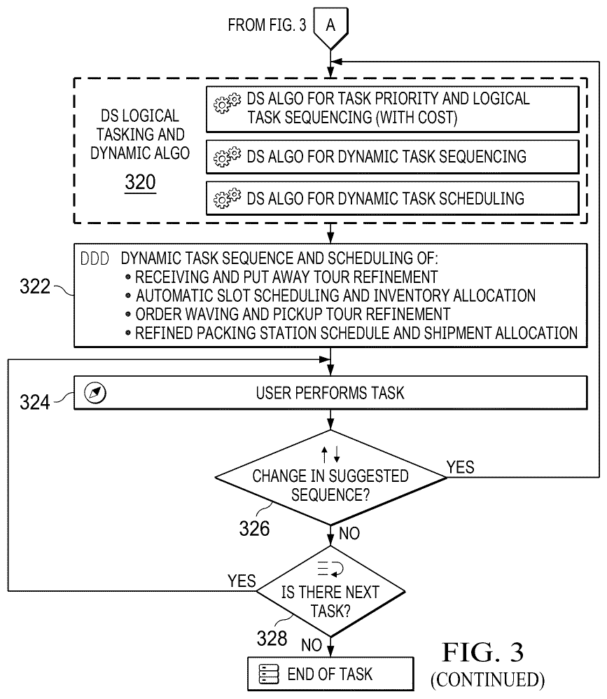

FIG. 3 illustrates example method 300 for executing and monitoring changes in a warehouse plan, according to an embodiment. Method 300 may be performed by a warehouse tasking system, such as warehouse tasking system 110 of FIG. 1. Method 300 proceeds by one or more activities 302-328, which although described in a particular order may be performed in one or more permutations, combinations, orders, or repetitions, according to particular needs.

At first activity 302 warehouse tasking system 110 receives an initial warehouse plan for a particular warehouse or distribution center of supply chain network 100. In embodiments, the warehouse plan may be received from planning and execution system 130 or from archiving system 120. The warehouse plan may include various instructions, tasks or other planning information for the warehouse, including a put-away or inbound slotting plan for arriving inventory and a pick-up or outbound fulfillment plan for orders to be fulfilled.

At second activity 304 warehouse tasking system 110 receives a changed warehouse plan describing a changed warehouse plan for the warehouse. In embodiments, the changed warehouse plan may be received from planning and execution system 120 or from archiving system 130. The changed warehouse plan may include updates to the initial warehouse plan based on one or more planning changes, such as modified warehouse slotting plans or modified fulfillment plans, which may be generated based on changed conditions or predictions for supply chain network 100.

At third activity 306 warehouse tasking system 110 receives user input defining a scope for warehouse analysis. For example, the user input may limit the scope for analysis to a single aisle of the warehouse, a single shift of the warehouse, warehouse tasks relating to particular resources or equipment of the warehouse, although any subdivision of a warehouse plan may be used, including multiple aisles, multiple shifts, multiple resources or equipment or any combination thereof.

At fourth activity 308 warehouse tasking system 110 captures, via one or more sensors of the warehouse, various real-time data which may be used to determine execution changes within the warehouse. For example, one or more cameras or sensors including IoT sensors may be used to capture data relating to executed tasks and the progress of task execution and resource or equipment usage data.

At fifth activity 310 warehouse tasking system 110 identifies warehouse execution changes based on the data captured at fourth activity 308. For example, warehouse tasking system 110 may determine, based on visual data indicating that inventory required to perform a particular task is not in the correct area, that a task to move that inventory to the correct area should be generated. As a further example, warehouse tasking system 110 may determine based on an IoT sensor attached to a forklift required for a particular task, that the forklift is currently in use and that a new task should be generated for the employee assigned to the task requiring the forklift until the forklift is available again.

At sixth activity 312 warehouse tasking system 110 outputs an execution changes report for the execution changes identified at fifth activity 310. For example, the execution changes report may include tasking delays and need of new assignment, resource challenges including resource unavailability, damage or limited functionality, identification of needed sub-movements for a particular slot, labor availability or unavailability and any possibility of cross-functioning of resource and labor usage. In embodiments, the execution changes report may be utilized at third activity 306 when limiting the scope of warehouse analysis, for example, to limit the scope of analysis to particular execution changes or kinds of execution changes.

At seventh activity 314 warehouse tasking system 110 uses the initial warehouse plan received at first activity 302, the changed warehouse plan received at second activity 304, the execution changes report generated at sixth activity 312 and the scope of analysis defined at third activity 306 to identify changes in the warehouse plans and generate tasks needed to implement those changes. In embodiments, warehouse tasking system 110 may compare the initial warehouse plan report with the changed warehouse plan, limited in scope as defined by user input, to identify changes between the initial warehouse plan and the changed warehouse plan. In embodiments warehouse tasking system 110 may also receive user input refining the scope of the changes identified by warehouse tasking system 110, such as only showing a single type of changes or any other subdivision of the changes identified.

At eighth activity 316 warehouse tasking system 110 generates a task & changes report based on the changes identified at seventh activity 314. In embodiments, the task & changes report may include the overall change report and the generated tasks needed to implement the changes. For example, the tasks may include moving inventory from one location of the warehouse to another, unloading inventory from inbound vehicles, placing inventory on outbound vehicles or any other tasks needed to implement the changes identified in the warehouse plans or any changes detected in warehouse execution.

At ninth activity 318 warehouse tasking system 110 receives warehouse info for the warehouse. For example, the warehouse info may include travel routes and aisles of the warehouse, slots and stacked product information for the warehouse, area and location information for the warehouse, information related to resources and equipment of the warehouse, information related to labor and tasks assigned to labor including the impact on planning data or any other information related to the layout or operation of the warehouse.

At tenth activity 320 warehouse tasking system 110 determines a task priority and task schedule for the tasks generated at seventh activity 314. In embodiments, the warehouse info received at ninth activity 318 may be used to determine the task priority and task schedule. For example, the aisle layout of the warehouse may be used to determine a shortest possible path between warehouse locations, which may then be used to determine a task priority that allows tasks to be sequenced with a minimum distance to be traveled between tasks.

At eleventh activity 322 warehouse tasking system 110 outputs a dynamic task sequence and task schedule. In embodiments, the dynamic task schedule may be based on task optimizations including refinements to receiving and put-away tours, automatic slot scheduling and inventory allocation, refinements to order batching and pick-up tours and refined packing station schedules and shipment allocations. In embodiments, the dynamic task schedule may be transmitted to one or more devices associated with employees of the warehouse, such as one or more tablets, smartphones or other computing devices.

At twelfth activity 324 warehouse tasking system 110 begins monitoring user performance of the dynamic task schedule, by receiving a confirmation that the user has performed a task of the dynamic task schedule. For example, by analysis of video data of cameras located within the warehouse, warehouse tasking system 110 may determine if a task has been performed. In embodiments, warehouse tasking system 110 may receive location information from IoT enabled devices or other devices associated with users or employees to determine user location and thus, the progress of task performance.

At thirteenth activity 326 warehouse tasking system 110 determines, based on user performance of the task, if the task schedule should be changed. For example, if a task is performed out of sequence according to the dynamic task schedule, or a task that was not scheduled to be performed was performed, warehouse tasking system 110 may determine that a change to the task schedule is required. If warehouse tasking system 110 determines that a change in the task schedule is required, method 300 returns to eleventh activity 322, where a new dynamic task schedule is generated.

If, however, warehouse tasking system 110 determines no change in the suggested task schedule is required, at fourteenth activity 328 warehouse tasking system 110 determines if there is a next task in the task schedule. If there is a next task, method 300 returns to twelfth activity 324. If, however, there is no next task in the task schedule, method 300 ends.

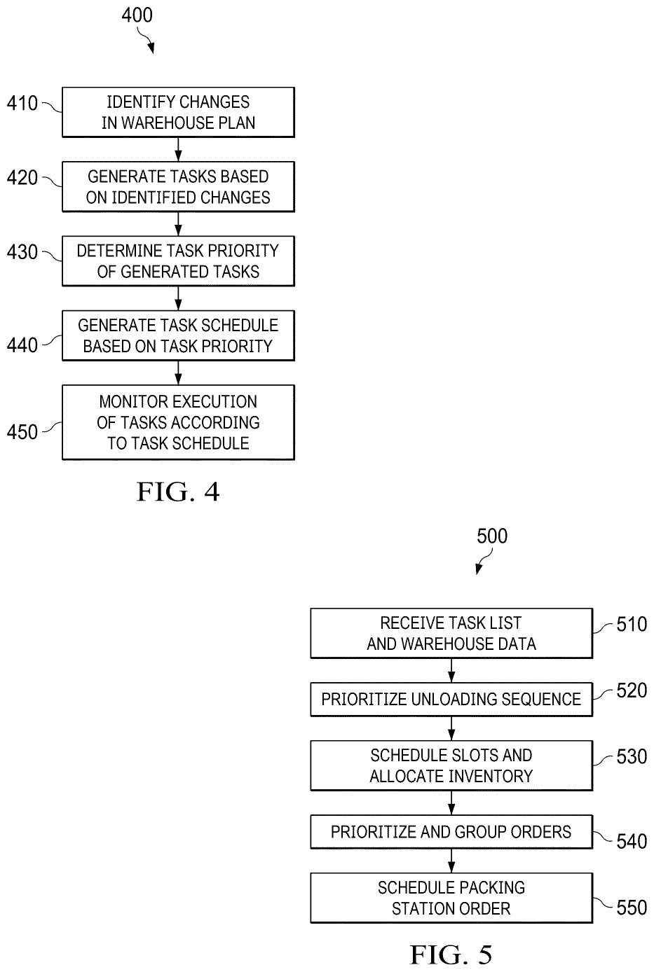

FIG. 4 illustrates example method 400 for generating and scheduling warehouse tasks, according to an embodiment. Method 400 may be performed by a warehouse tasking system, such as warehouse tasking system 110 of FIG. 1. Method 400 proceeds by one or more activities 410-450, which although described in a particular order may be performed in one or more permutations, combinations, orders, or repetitions, according to particular needs.

At first activity 410 warehouse tasking system 110 identifies changes in a warehouse plan for a warehouse within supply chain network 100. For example, warehouse tasking system 110 may compare an initial warehouse plan with a changed or updated warehouse plan to identify changes between the initial warehouse plan and the updated warehouse plan. As described in further detail above, changes may include the addition or removal of orders to be fulfilled, the addition or removal of new inventory to be put away from inbound vehicles, planning changes related to warehouse operations or any other change detected between warehouse plans. In embodiments, warehouse tasking system 110 may also identify changes in warehouse execution based on real-time data captured within the warehouse, such as unplanned unavailability of resources, equipment or labor, although other possible warehouse execution changes are described in further detail above.

At second activity 420 warehouse tasking system 110 generates tasks based on the changes identified at first activity 410. In general, warehouse changes may require a set of tasks in order to be implemented fully. For example, if one warehouse change includes new orders to be fulfilled from the warehouse, tasks required to implement that change may include moving inventory out of a staging area, moving inventory corresponding to the new orders to the staging area and then loading the inventory corresponding to the new orders from the staging area to a delivery vehicle. Although a simplified example is presented here for ease of explanation, in practice actual warehouse changes may require many more tasks to be fully implement, even when the total number of changes is low.

At third activity 430 warehouse tasking system 110 determines a task priority of the tasks generated at second activity 420. To maximize efficiency of task performance, warehouse tasking system 110 may use various data streams, including layouts and operating details of the warehouse, to determine a task sequence that can be performed as quickly as possible or in as few steps as possible for users. For example, if a set of tasks take place across several different aisles of the warehouse, the task priority determined for the set of tasks would be organized for each aisle to be reached in sequence of physical distance, instead of a pattern that takes the user back and forth between aisles far apart.

At fourth activity 440 warehouse tasking system 110 generates a task schedule based on the task priority generated at third activity 430. Because warehouse tasks or jobs frequently involve the use of various equipment or vehicles, a fixed schedule for warehouse tasks can greatly increase the efficiency of task performance by effectively allocating the usage of equipment and vehicles. Warehouse tasking system 110 may utilize real-time resource and equipment utilization data to determine the availability of resources and equipment, including the current and expected location of vehicles, which in turn can be used to generate a dynamic task schedule for the warehouse. In embodiments, the dynamic task schedule may updated during execution in order to adjust to warehouse execution changes, such as breakdowns or loss of functionality in the resources or equipment.

At fifth activity 450 warehouse tasking system 110 monitors execution of the tasks generated at second activity 420 according to the task schedule determined at fourth activity 440. Warehouse tasking system 110 may monitor execution in real time via devices associated with the warehouse, including cameras or other sensors installed in the warehouse, as well as devices associated with employees of the warehouse including smartphones, tablets or other devices, such as IoT devices, that can transmit location data. In embodiments, if a task is performed out of sequence or out of schedule, or a task that was not in the set of tasks was performed, or the user has otherwise deviated from the task schedule, warehouse tasking system 110 may perform dynamic re-sequencing and dynamic re-scheduling to account for the deviation. Warehouse tasking system 110 may then transmit an updated task schedule to the devices associated with the employees. In embodiments, the warehouse tasking system 110 may perform dynamic rescheduling in real time to account for deviations in task schedule and transmit in real time an updated task schedule. For example, if an error occurs by a user executing a task, the warehouse tasking system 110 may detect the error in real time and transmit in real time one or more tasks to a mobile device of the user to account for the error. Warehouse tasking system 110 may monitor execution of the tasks and send new task schedules as needed, until all tasks of the task schedule have been performed.

FIG. 5 illustrates example method 500 for optimizing warehouse tasks, according to an embodiment. Method 500 may be performed by a warehouse tasking system, such as warehouse tasking system 110 of FIG. 1. Method 500 proceeds by one or more activities 510-550, which although described in a particular order may be performed in one or more permutations, combinations, orders, or repetitions, according to particular needs.

At first activity 510 warehouse tasking system 110 receives a task list and warehouse data associated with a particular warehouse of supply chain network 100. As described in further detail above, the task list may be generated by warehouse tasking system 110 based on a set of changes detected by comparing initial and updated warehouse plans, or by detecting changes in warehouse execution using real-time data.

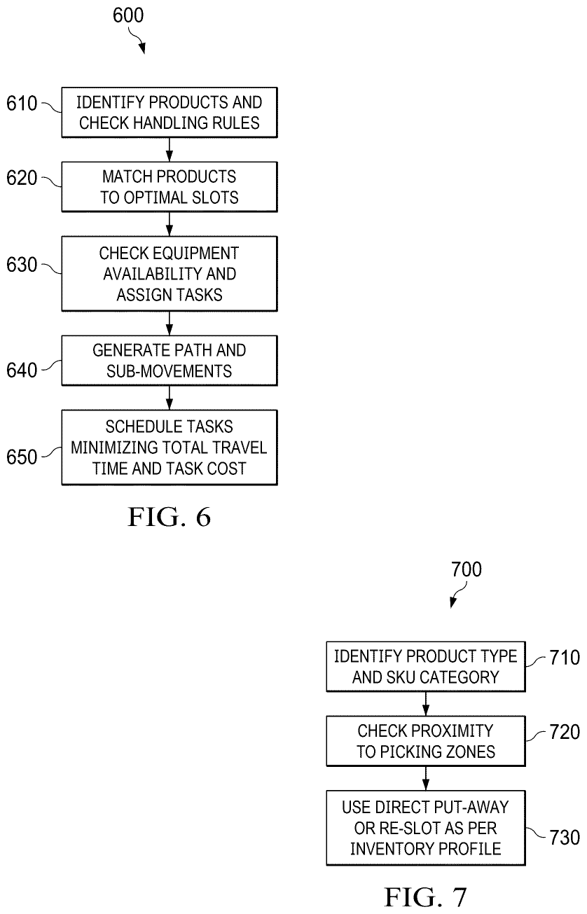

At second activity 520 warehouse tasking system 110 prioritizes an unloading sequence for the warehouse. In embodiments, warehouse tasking system 110 may prioritize the unloading sequence, including put-away paths, based on inventory demand, space efficiency and other constraints of the warehouse. As an example only and not by way of limitation, if an inbound truck includes both food products and products with hazardous materials, warehouse tasking system 110 may determine an unloading sequence that unloads the food products first and unloads the products with hazardous materials second and may determine separate put-away paths for the products to keep the food products and the products with hazardous materials separated. One possible method for prioritizing unloading sequences is described in further detail below with respect to FIG. 6.

At third activity 530 warehouse tasking system 110 schedules slots and allocates inventory for the warehouse. In embodiments, warehouse tasking system 110 may schedule slots and allocate inventory based on considerations including product type, travel time and similarity of inventory. Continuing the example in second activity 520 above, warehouse tasking system 110 may determine the foot products are higher demand products and consequently slot the food products into a pick zone where near-term orders may be fulfilled more quickly compared to the products with hazardous materials. One possible method for scheduling slots and allocating inventory is described in further detail below with respect to FIG. 7.

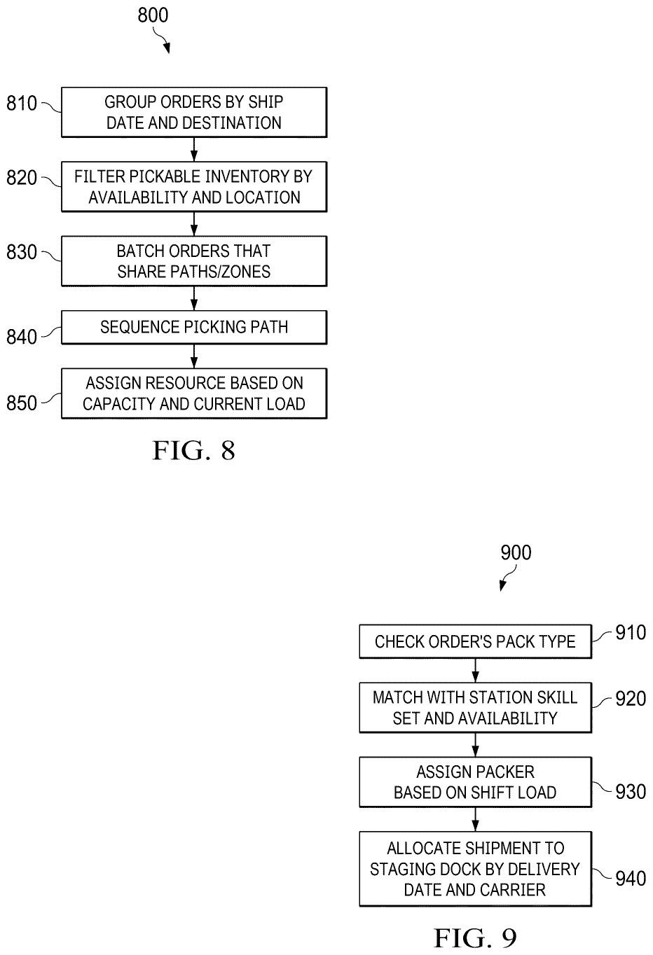

At fourth activity 540 warehouse tasking system 110 prioritizes and groups orders for the warehouse. In embodiments, warehouse tasking system 110 may prioritize and group, or batch, orders based on considerations including ship date, inventory type, destination and zone and may generate pick tours with sequenced pith paths to minimize travel time between picks. As an example only and not by way of limitation, if warehouse tasking system 110 determines that six orders of the warehouse are to be delivered to the same area of a particular city, warehouse tasking system 110 may group the six orders into a single batch and assign the batched orders to a single picker of the warehouse, who may be selected based on a current light workload for tasks. One possible method for prioritizing and grouping orders is described in further detail below with respect to FIG. 8.

At fifth activity 550 warehouse tasking system 110 schedules packing station order for the warehouse. In embodiments, warehouse tasking system 110 automatically schedules an order or sequence for packing based on considerations including pack type, skills of the packers, shipment locations and load types. As an example only and not by way of limitation, if warehouse tasking system 110 determines that three orders of the warehouse require fragile packaging, warehouse tasking system 110 allocate the three orders to a single packer and packing station who is tagged as having the required fragile handling skills. One possible method for scheduling packing station order is described in further detail below with respect to FIG. 7.

FIG. 6 illustrates example method 600 for optimizing receiving and put away tours, according to an embodiment. Method 600 may be performed by a warehouse tasking system, such as warehouse tasking system 110 of FIG. 1. Method 600 proceeds by one or more activities 610-650, which although described in a particular order may be performed in one or more permutations, combinations, orders, or repetitions, according to particular needs. In embodiments, warehouse tasking system 110 may perform method 600 using associated with a particular warehouse of supply chain network 100, including inbound product data, warehouse data and a task list for the warehouse, as described in further detail above.

At first activity 610 warehouse tasking system 110 identifies inbound products to be put away for or at the warehouse and checks handling rules for the inbound products. For example, handling rules may include handling rules for food products or handling rules for hazardous products or any other rules requiring products to be stored in particular locations in the warehouse or restricting or requiring travel paths through the warehouse.

At second activity 620 warehouse tasking system 110 matches the products identified at first activity 610 to optimal slots or other storage areas in the warehouse considering factors including demand frequency, slot proximity and equipment compatibility. In embodiments, warehouse tasking system 110 may generate a list of all eligible warehouse slots according to the handling rules checked at first activity 610 and thereafter score or rank the eligible warehouse slots to determine an optimal slot for each inbound product. A determine optimal slot is removed from the list of eligible warehouse slots when full so that no further products are assigned to a filled slot and the optimal slot for a next product will be selected from the remaining eligible warehouse slots.

At third activity 630 warehouse tasking system 110 checks equipment availability within the warehouse and assigns tasks to available equipment, where the assigned tasks include putting away the inbound products identified at first activity 610 to the optimal slots matched at second activity 620. In embodiments, warehouse tasking system 110 may access real-time equipment availability data via one or more sensors in the warehouse to determine equipment availability. If a requested piece of equipment is available, warehouse tasking system 110 assign a task to the equipment and may assign the task to a particular worker or robotic resource of the warehouse as required.

At fourth activity 640 warehouse tasking system 110 generates put-away paths and sub-movements for the tasks assigned at third activity 630. In embodiments, warehouse tasking system 110 generates the paths and sub-movements based on product weight, size and volume compared to warehouse route sizes, vehicle or equipment sizes compared to passage sizes and slot accessibility. Warehouse tasking system 110 may also use real-time warehouse traffic and congestion data to determine what paths through the warehouse are clear or open for travel and may generate put away paths using the clear or open paths through the warehouse to minimize warehouse congestion.

At fifth activity 650 warehouse tasking system 110 schedules the tasks generated and assigned at third activity 630 in order to minimizing total travel time through the warehouse and route cost based on the put-away paths and sub-movements generated at fourth activity 640. In embodiments, warehouse tasking system 110 may schedule the tasks by adding the task to a task list and generating an estimate task completion time, and may add the task to a schedule associated with the assigned worker or assigned robotic resource as well as any assigned equipment or other resources.

To further illustrate the operation of method 600, consider the following example. Warehouse A is scheduled to receive an inbound truck including both food products and hazardous products. At first activity 610, warehouse tasking system 110 identifies the food and hazardous products and determines the handling rules required for each. At second activity 620, warehouse tasking system 110 matches the food products to Zone B of the warehouse which is equipped to store food products and matches the hazardous products to Zone C of the warehouse which is equipped with to store hazardous products. At third activity 630, warehouse tasking system 110 determines a forklift with lifting capacity over 300 kg is required to move the foot products and a task to move the food products to Zone B is assigned to an available forklift with the required lifting capacity. At fourth activity 640, warehouse tasking system 110 generates a put-away path for the forklift and the food products which avoids a blocked aisles in Warehouse A. At fifth activity 650, warehouse tasking system 110 assigns the task and the put-away path to a worker of Warehouse A and schedules the task to be performed during unloading of the inbound truck. Thereafter, warehouse tasking system 110 may monitor the task progress of the scheduled task and reassign the task or update the put-away path as required.

FIG. 7 illustrates example method 700 for optimizing slot schedules and inventory allocations, according to an embodiment. Method 700 may be performed by a warehouse tasking system, such as warehouse tasking system 110 of FIG. 1. Method 700 proceeds by one or more activities 710-750, which although described in a particular order may be performed in one or more permutations, combinations, orders, or repetitions, according to particular needs. In embodiments, warehouse tasking system 110 may perform method 700 using associated with a particular warehouse of supply chain network 100, including stored product data, warehouse data and a task list for the warehouse, as described in further detail above. Method 700 may be performed periodically or on demand based on updates to demand data for stored products or new or unexpected inbound products that may require the reorganization or movement of stored products in the warehouse.

At first activity 710 warehouse tasking system 110 identifies product types and SKU categories for the warehouse based on the stored product data and inbound product data. For example, warehouse tasking system 110 may identify whether a particular product or SKU is high demand or low demand based on updated demand data or may identify whether a particular product type or SKU is temporarily hot due to expected orders in the near term. Warehouse tasking system 110 may also identify or confirm that a particular product type or SKU is hazardous or has other special handling or storage rules that would limit the rescheduling or movement of such product types or SKUs.

At second activity 720 warehouse tasking system 110 checks proximity to picking zones of the warehouse for the product types and SKU categories identified at first activity 710. For example, may check the proximity of a currently stored, high-demand SKU to a pick zone of the warehouse to determine if the high-demand SKU can be picked quickly or if the high-demand SKU should be moved to a slot closer to the pick zone. In embodiments, warehouse tasking system 110 may avoid mixing incompatible SKUs or product types when checking proximity to picking zones. For example, if a particular high-demand SKU is also a hazardous product with special hazardous materials handling rules, warehouse tasking system 110 will only consider moving the high-demand SKU to slots that are equipped to receive hazardous products.

At third activity 730 warehouse tasking system 110 uses direct put-away or re-slot as per inventory profile based on the product types identified at first activity 710. Warehouse tasking system 110 may determine whether to directly put-away a newly received product to a new slot based on the inventory profile (e.g., a low demand profile that can be placed in a non-prime warehouse slot) or to re-slot an already stored product to make way for a newly received product based on the inventory profile (e.g., a high demand profile that should always be placed in a prime warehouse slot if possible). In embodiment, the use of method 700 may allow warehouse tasking system 110 may avoid skip-picks and SLA issues by placing high priority and high demand products in easily and quickly accessible slots of warehouse, even if products must initially be arranged to allow new products to be stored in such slots.

To further illustrate the operation of method 700, consider the following example. Warehouse A is currently storing SKU B and SKU C. SKU B is predicted to be in high demand in the near term with many orders expected and SKU C is a hazardous product kept in an isolated area of Warehouse A. At first activity 710, warehouse tasking system 110 identifies the high-demand and hazardous status for SKU B and SKU C respectively. At second activity 720, warehouse tasking system 110 checks the proximity of SKU B to the picking zone of Warehouse A and determines that SKU B is currently in a bulk zone located far from the picking zone. Warehouse tasking system 110 further determines that SKU C is located in the isolated area which is near the picking zone but is the only hazardous material area in Warehouse A. At third activity 730, warehouse tasking system 110 determines to re-slot SKU B into a slot near the picking zone and move a product currently in the slot to the bulk zone, and thereafter generates and assigns a re-slot task for SKU B and the other product to be moved.

FIG. 8 illustrates example method 800 for optimal order batching and pick tours, according to an embodiment. Method 800 may be performed by a warehouse tasking system, such as warehouse tasking system 110 of FIG. 1. Method 800 proceeds by one or more activities 810-850, which although described in a particular order may be performed in one or more permutations, combinations, orders, or repetitions, according to particular needs. In embodiments, warehouse tasking system 110 may perform method 800 using associated with a particular warehouse of supply chain network 100, including outbound order data, warehouse data and a task list for the warehouse, as described in further detail above.

At first activity 810 warehouse tasking system 110 groups orders of the outbound order data by ship date and destination. For example orders with the same destination city and the same shipping date may be grouped together, although larger (e.g., regions, states or other groupings) and smaller (e.g., neighborhoods or districts of a city) geographic boundaries may be used to group orders.

At second activity 820 warehouse tasking system 110 filters pickable inventory of the orders by availability in the warehouse and location in the warehouse. For example, even if two orders with the same destination and ship date are grouped together at first activity 810, if one product of one of the orders is not currently available in the warehouse, that order will be filtered out of the order grouping.

At third activity 830 warehouse tasking system 110 batches together orders that share picking paths or picking zones in the warehouse. For example, for orders that have been grouped together at first activity 810 and not filtered by second activity 820, warehouse tasking system 110 may subdivide the grouped orders into batches based on ability of each batch to be picked in a single picking tour or along a single picking path.

At fourth activity 840 warehouse tasking system 110 sequences a picking path for the orders batched together at third activity 830 based on a sequence that results in a shortest time to complete the picking path and least effort to complete the picking path. For example, if a warehouse has aisles 1-10 ordered with 1 being closest to the entrance of the warehouse and 10 being furthest from the entrance of the warehouse, and a single batch of orders includes products in aisles 1, 9 and 10, then warehouse tasking system will sequence a picking path for that batch that does not require the picker to go to the back of the warehouse twice (e.g., picking 1, then 9, then 10) to complete the pick path, minimizing the time and effort to complete the pick path.

At fifth activity 850 warehouse tasking system 110 assigns resources, including pickers, robotic machinery and equipment or vehicles, to the batched orders based on resource capacity of the warehouse and current load of the warehouse and the resources assigned. For example, warehouse tasking system 110 may assign a batch of orders with many orders to a picker with a currently light workload while assigning a batch of orders with few orders to a picker with a currently heavy workload.

To further illustrate the operation of method 800, consider the following example. At first activity 810, warehouse tasking system 110 determines that Warehouse A has 6 outstanding orders going to the same city and 3 of those orders include identical SKUs. At second activity 820, warehouse tasking system 110 determines that all SKUs are available in warehouse A and does not filter any of the orders. At third activity 830, warehouse tasking system 110 batches the three orders to a single picker route. At fourth activity 840, warehouse tasking system 110 sequences a picking path that bases through Zones 1, 2 and 3 of Warehouse A in a U-shape to minimize backtracking for the picker. At fifth activity 850, warehouse tasking system 110 identifies a picker with a currently light workload and assigns the batched orders and picking path to the picker. Thereafter, warehouse tasking system 110 may monitor the task progress of the pick path and reassign the path or update the pick path as required based on changes to the congestion and resource status of Warehouse A.

FIG. 9 illustrates example method 900 for optimal pack station scheduling and shipment allocation, according to an embodiment. Method 900 may be performed by a warehouse tasking system, such as warehouse tasking system 110 of FIG. 1. Method 900 proceeds by one or more activities 910-950, which although described in a particular order may be performed in one or more permutations, combinations, orders, or repetitions, according to particular needs. In embodiments, warehouse tasking system 110 may perform method 900 using associated with a particular warehouse of supply chain network 100, including outbound order data, warehouse data and a task list for the warehouse, as described in further detail above.

At first activity 910 warehouse tasking system 110 checks the pack type of all orders of the outbound order data. For example, pack types may include handling rules or other special statuses, such as a fragile pack type or a bulk pack type. At second activity 920 warehouse tasking system 110 matches the orders to an available packing station with a skill set matching the pack types checked at first activity 910. For example, warehouse tasking system 110 may use real-time resource data of the warehouse to determine whether a particular packing station is available for assignment.

At third activity 930 warehouse tasking system 110 assigns a packer to the packing station matched at second activity 920 based on shift load for the packer. For example, warehouse tasking system 110 may use real-time resource data and task and schedule data of the warehouse to determine whether pickers have availability for additional assignments. The packer assigned to the packing station will pack the orders according to the pack type and handling rules checked at first activity 910 into one or more shipments comprising one or more orders which are ready to be loaded onto transportation vehicles.

At fourth activity 940 warehouse tasking system 110 allocates the one or more shipments to a staging dock of the warehouse according to the delivery dates of the orders and carriers assigned to the shipments. For example, shipments scheduled to be delivered on the same day and by the same carrier will be assigned to a particular staging or loading dock, and each staging or loading dock may be assigned only orders or shipments assigned to a single carrier.

To further illustrate the operation of method 900, consider the following example. At first activity 910, warehouse tasking system 110 checks order pack types for Warehouse A and determines that 3 outstanding orders require fragile packaging. At second activity 920, warehouse tasking system 110 matches the 3 fragile orders to a packing station with a fragile skill set and which is available based on real-time warehouse status data. At third activity 930, identifies a packer with available capacity and assigns the packer to the packing station and the 3 fragile orders. Once the packing is complete, at fourth activity 940 warehouse tasking system 110 allocates the 3 packed orders to a single shipment including other orders with the same delivery date and assigned carrier and allocates the shipment to a staging dock associated with the assigned carrier.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for generating and scheduling warehouse tasks, comprising:
a computer comprising a processor and memory and configured to:
identify changes in a warehouse plan for a warehouse within a supply chain network;
generate tasks based on the identified changes;
determine a task priority of the generated tasks;
generate a task schedule based on the determined task priority; and
monitor real time execution of the generated tasks according to the task schedule.

2. The system of claim 1, wherein the monitoring is performed via devices associated with the warehouse.

3. The system of claim 1, wherein the monitoring is performed by cameras or other sensors in the warehouse.

4. The system of claim 1, wherein the task schedule allocates usage of equipment and vehicles.

5. The system of claim 1, wherein the computer is further configured to:
perform, in real time, dynamic re-sequencing and dynamic re-scheduling to account for a deviation from the schedule.

6. The system of claim 1, wherein the computer is further configured to:
detect, in real time, an error and transmit, in real time, one or more tasks to a mobile device to account for the detected error.

7. The system of claim 1, wherein the computer is further configured to:
update the task schedule during execution of the task schedule to adjust for breakdowns or loss of functionality in resources and equipment.

8. A method for generating and scheduling warehouse tasks, comprising:
identifying, by a computer comprising a processor and memory, changes in a warehouse plan for a warehouse within a supply chain network;
generating, by the computer, tasks based on the identified changes;
determining, by the computer, a task priority of the generated tasks;
generating, by the computer, a task schedule based on the determined task priority; and
monitoring, by the computer, real time execution of the generated tasks according to the task schedule.

9. The method of claim 8, wherein the monitoring is performed via devices associated with the warehouse.

10. The method of claim 8, wherein the monitoring is performed by cameras or other sensors in the warehouse.

11. The method of claim 8, wherein the task schedule allocates usage of equipment and vehicles.

12. The method of claim 8, further comprising:
performing, by the computer in real time, dynamic re-sequencing and dynamic re-scheduling to account for a deviation from the schedule.

13. The method of claim 8, further comprising:
detecting, by the computer, an error in real time and transmit, in real time, one or more tasks to a mobile device to account for the detected error.

14. The method of claim 8, further comprising:
updating, by the computer, the task schedule during execution of the task schedule to adjust for breakdowns or loss of functionality in resources and equipment.

15. A non-transitory computer-readable medium embodied with software for generating and scheduling warehouse tasks, the software when executed is configured to:
identify changes in a warehouse plan for a warehouse within a supply chain network;
generate tasks based on the identified changes;
determine a task priority of the generated tasks;
generate a task schedule based on the determined task priority; and
monitor real time execution of the generated tasks according to the task schedule.

16. The non-transitory computer-readable medium of claim 15, wherein the monitoring is performed via devices associated with the warehouse.

17. The non-transitory computer-readable medium of claim 15, wherein the monitoring is performed by cameras or other sensors in the warehouse.

18. The non-transitory computer-readable medium of claim 15, wherein the task schedule allocates usage of equipment and vehicles.

19. The non-transitory computer-readable medium of claim 15, wherein the software when executed is further configured to:
perform, in real time, dynamic re-sequencing and dynamic re-scheduling to account for a deviation from the schedule.

20. The non-transitory computer-readable medium of claim 15, wherein the software when executed is further configured to:
detect an error in real time and transmit, in real time, one or more tasks to a mobile device to account for the detected error.
